(19) United States
(12) Patent Application Publication
(10) Pub. No.: US 2014/0241120 A1
(43) Pub. Date: Aug. 28, 2014

(54) MARINE SEISMIC APPARATUS WITH MARINE GROWTH RETARDANT AND METHODS THEREFOR

(71) Applicant: CGG SERVICES SA, Massy Cedex (FR)

(72) Inventors: Nigel BLACKHALL, Selzen (DE); Raphael MACQUIN, Montrouge (FR)

(73) Assignee: CGG SERVICES SA, Massy Cedex (FR)

(21) Appl. No.: 14/061,983

(22) Filed: Oct. 24, 2013

Related U.S. Application Data
(60) Provisional application No. 61/767,836, filed on Feb. 22, 2013.

(51) Int. Cl. G01V 1/38

(52) U.S. Cl. CPC G01V 1/3826; G01V 1/38
USPC 367/17; 367/15

(57) ABSTRACT

Embodiments describe methods, devices and systems for marine seismic surveying which prevent or inhibit marine growth thereon. Towed seismic array elements which can become fouled given their presence in the water for extended time periods are coated with a hydrophobic coating, e.g., a superhydrophobic nanocoating applied manually via an aerosol can or brush. Application of the hydrophobic coating can be performed on board the towing vessel, or even potentially in the water.

### PRIORITY INFORMATION

The present application claims priority under 35 U.S.C. §119(e) to U.S. Provisional Patent Application Ser. No. 61/767,836, filed Feb. 22, 2013, the entire contents of which are expressly incorporated herein by reference.

### TECHNICAL FIELD

The present embodiments relate generally to marine seismic acquisition systems, devices and methods and, more specifically, to systems and methods for inhibiting marine growth on such systems and devices.

### BACKGROUND

Seismic waves generated artificially for the imaging of geological layers have been used for more than 50 years. Reflection seismology is a method of geophysical exploration used to determine the properties of a portion of a subsurface layer in the earth, which information is especially helpful in the oil and gas industry. Marine-based seismic data acquisition and processing techniques are used to generate a profile (image) of a geophysical structure (subsurface) of the strata underlying the seafloor. While this profile does not necessarily precisely pinpoint the exact location of oil or gas reservoirs, it may suggest, to those trained in the field, the presence or absence of oil or gas reservoirs. The generation of these images requires significant data processing which can take a long time, and is subject to noise and other error sources which may impact the accuracy of the images. Thus, providing an improved image of the subsurface in a shorter period of time is a matter of ongoing research to those involved in the design of seismic acquisition systems.

The overall seismic acquisition process includes generating seismic waves (i.e., sound waves) directed toward the subsurface area, gathering data associated with reflections of the generated seismic waves at interfaces between the layers of the subsurface, and analyzing the data to generate a profile (image) of the geophysical structure, i.e., the layers of the investigated subsurface. This type of seismic acquisition or exploration can be used both on the subsurface of land areas and for exploring the subsurface of the ocean floor.

Marine reflection seismology is based on the use of a controlled source that sends energy waves into the earth, by first generating the energy waves in or on the ocean. By measuring the time it takes for the reflections to come back to one or more receivers (usually quite a few reflections, perhaps on the order of several dozen, or even hundreds), it is possible to estimate the depth and/or composition of the features causing such reflections. These features may be associated with subterranean hydrocarbon deposits.

One of the ways to perform marine seismic acquisitions or surveys is to tow an array of acoustic sources and receivers, some or both of which may be disposed on streamers, by a vessel over the geographical area of interest (GAI) and to generate source signals and receive corresponding reflections while traversing the GAI. This process is sometimes referred to by those skilled in the art as “shooting” a GAI or cell being surveyed. A detailed example of a marine seismic acquisition system is described below with respect to FIGS. 1 and 2. As will be appreciated by those skilled in the art, these source and/or receiver arrays may be submerged in the ocean waters for long periods of time and, accordingly, are susceptible to marine growth such as barnacles and marine algae. As such marine growth forms on the arrays and their components, this can cause various problems including: an increase drag on the arrays which, in turn, results in lower shooting speeds, an increase in fuel usage, an increase in wear to streamer head equipment associated with increased tension on the arrays and a degradation of the received data due to an increase in noise.

As described in U.S. Pat. No. 7,145,833 (the '833 patent), streamers can be cleaned of such attached marine growth or other contaminants using conventional methods such as brushing and scraping of the streamers. However, such conventional cleaning methods typically require the streamer to be retrieved from the water which, in turn, typically involves spooling or winding the streamer on a suitable winch or similar device. The streamer must then be transported to a facility where it may be unspooled and then cleaned. Such conventional cleaning procedures can be difficult and expensive to perform, and may require that the streamer be removed from service for a considerable period of time. Alternatively, a streamer can be scraped or cleaned manually from a boat moved alongside the streamer while the streamer is deployed in the water. Such cleaning operations can be difficult to perform, dangerous to personnel in the event of unexpected rough water, and, depending on the skill of the cleaning operator, may risk damage to the streamer.

The '833 patent proposes to solve these conventional problems by providing a mechanical cleaning device which purports to automatically traverse and clean the streamers of marine growth while the streamers are deployed in the water. However, such a solution does not address how such a mechanical device can traverse and clean those surfaces which are irregular, such as the birds, nor does it contemplate cleaning harder to reach surfaces, e.g., interior surfaces of the birds. Moreover, such a mechanical cleaning device still requires that time be dedicated to the cleaning process during which time it is unlikely that the seismic acquisition system can be used to perform a survey.

Instead, it would be desirable to avoid (or at least retard) marine growth in the first instance. Accordingly, it would be desirable to provide methods, systems and devices to address the problems associated with conventional seismic acquisition systems.

### SUMMARY

An aspect of the embodiments is to solve, or at least substantially address, at least one or more of the problems and/or disadvantages discussed above, and/or to provide at least one or more of the advantages described in the Detailed Description below. It is therefore a general aspect of the embodiments to provide a technique for retarding or preventing marine growth on marine seismic surveying equipment that will obviate or minimize problems of the type previously described. It will be appreciated, however, that the scope of the invention, as defined by the appended claims, does not necessarily require such beneficial results except to the extent that such results are explicitly recited in the claims.

According to a first aspect of the embodiments, a marine seismic acquisition system adapted to retard marine growth includes at least one towing vessel, at least one source disposed on, or connected to, the at least one towing vessel and configured to generate acoustic waves, at least one streamer connected to the at least one towing vessel and having a plurality of receivers associated therewith, the plurality of receivers configured to receive reflections of the acoustic waves and a plurality of birds attached to the at least one streamer and configured to assist in positioning the at least one streamer, wherein at least one surface of either the at least one streamer, the at least one source and the plurality of birds is coated with a superhydrophobic nanocoating which has a contact angle with water of at least 150 degrees.

According to a second aspect of the embodiments, a marine seismic acquisition system adapted to retard marine growth includes at least one streamer having a plurality of receivers associated therewith, the plurality of receivers configured to receive reflections of said acoustic waves; and a plurality of birds attached to the at least one streamer and configured to assist in positioning the at least one streamer, wherein at least one surface of either the at least one streamer and the plurality of birds is coated with a hydrophobic coating which has a contact angle with water of at least 90 degrees.

According to a third aspect of the embodiments, a marine seismic acquisition system adapted to retard marine growth includes at least one piece of seismic surveying equipment which has a hydrophobic coating on a surface thereof

According to a fourth aspect of the embodiments, a method for protecting marine seismic surveying equipment from marine growth includes the step of manually applying a hydrophobic coating to the marine seismic surveying equipment including one or more streamers having receivers and birds attached thereto using an aerosol can containing the hydrophobic nanocoating or a brush. The hydrophobic coating can be a superhydrophobic nanocoating.

According to a fifth aspect of the embodiments, a method for processing seismic data with reduced noise includes the steps of acquiring seismic data using seismic equipment including at least one streamer having at least one bird attached thereto which are substantially unfouled with marine life, wherein the seismic equipment is substantially unfouled with marine life due to at least one surface of either the at least one streamer and the at least one bird being coated with a hydrophobic coating which has a contact angle with water of at least 90 degrees, wherein the acquired seismic data has reduced noise relative to seismic data which would be acquired using seismic equipment which is fouled with marine life, and processing the acquired seismic data to produce an image of a geographical area of interest.

### BRIEF DESCRIPTION OF THE DRAWINGS

The above and other aspects of the embodiments will become apparent and more readily appreciated from the following description of the embodiments with reference to the following figures, wherein like reference numerals refer to like parts throughout the various figures unless otherwise specified, and wherein:

FIG. 1 illustrates a top view of a marine seismic acquisition or exploration system;

FIG. 2 illustrates a side view of the marine seismic exploration system of FIG. 1 and pictorially represents transmitted, reflected and refracted seismic waves;

FIG. 3 illustrates a general method for seismic exploration;

FIG. 4(a) shows examples of water contact angles;

FIG. 4(b) depicts a method for applying a superhydrophobic nanocoating according to an embodiment;

FIG. 5 shows a bird connected to a streamer and having a superhydrophobic nanocoating applied to surface(s) thereof using an aerosol can;

FIG. 6 illustrates a partial side view of another embodiment of the marine seismic exploration system shown in FIG. 1, wherein a curved streamer profile is implemented according to an embodiment; and

FIG. 7 illustrates a multi-level source for use with the marine seismic exploration system shown in FIG. 1 according to an embodiment.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will convey the scope of the inventive concept to those skilled in the art. It will be apparent to one skilled in the art, however, that at least some embodiments may be practiced without one or more of the specific details described herein. In other instances, well-known components or methods are not described in detail, or are presented in simple block diagram format, in order to avoid unnecessarily obscuring the embodiments. The scope of the embodiments is therefore defined by the appended claims.

Reference throughout the specification to “one embodiment” or “an embodiment” means that a particular feature, structure, or characteristic described in connection with an embodiment is included in at least one of the embodiments. Thus, the appearance of the phrases “in one embodiment” on “in an embodiment” in various places throughout the specification is not necessarily referring to the same embodiment. Further, the particular features, structures, or characteristics described herein may be combined in any suitable manner in one or more embodiments.

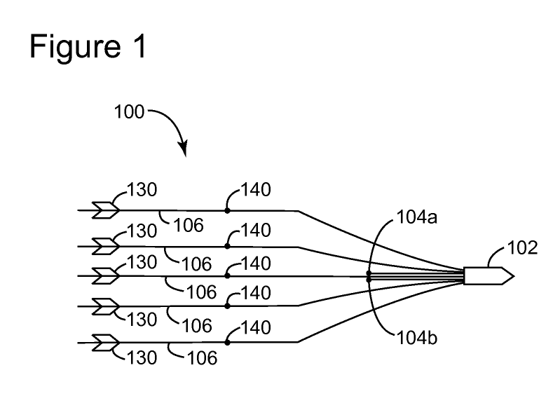

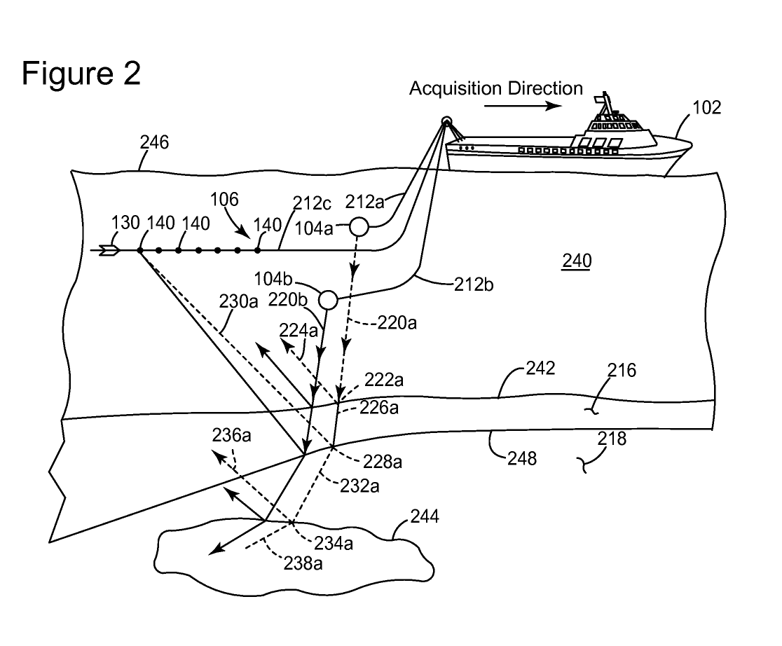

Prior to discussing techniques for retarding marine growth on marine seismic surveying equipment according to the embodiments, a brief discussion of marine seismic acquisition equipment and acquisition methods in general is provided for context. The subsequent embodiments may be practiced in these, or other, seismic acquisition systems. As seen in FIG. 1, an exemplary seismic acquisition system 100 includes a ship 102 towing plural streamers 106 that may extend over kilometers behind ship 102. Each of the streamers 106 can include one or more birds 130 that maintain the streamer 106 to which they are attached in a known and controllable position relative to other streamers 106 and, as will be appreciated by those skilled in the art, the birds 130 are capable of moving streamers 106 as desired according to communications or commands which birds 130 receive from ship 102. One or more sources (or source arrays) 104a,b may also be towed by ship 102 (or another ship, not shown) for generating seismic waves. Sources 104a,b can be placed either in front of or behind the receivers 140 which are attached to the streamers 106, or both behind and in front of receivers 140. The seismic waves generated by sources 104a,b propagate downwardly, and either reflect off of or penetrate the seafloor. The penetrating waves eventually are reflected by one or more reflecting structures (not shown in FIG. 1) which are disposed in the seafloor subsurface back toward the surface (see FIG. 2, discussed below). The reflected seismic waves propagate upwardly and are detected by receivers 140 provided on streamers 106. As mentioned above, this process is generally referred to as “shooting” a particular seafloor area, and the seafloor area can be referred to as a “cell”, or geographical area of interest (GAI).

To better understand the manner in which seismic waves are used to shoot a cell while performing a survey, FIG. 2 illustrates a side view of the seismic acquisition system 100 of FIG. 1 in the water. Ship 102, located on ocean surface 246 of ocean 240, tows one or more streamers 106 which are comprised of cables 212 and a plurality of receivers 140. Shown in FIG. 2 are two source arrays, which include sources 104a,b attached to respective cables 212a,b. Each source 104a,b is capable of transmitting a respective sound wave, or transmitted signal 220a,b. For the sake of simplifying the drawings, but while not detracting from an understanding of the principles involved, only the travel of a first transmitted signal 220a generated by source 104a will be discussed in detail (even though some or all of the sources 104 can be simultaneously (or not) transmitting similar signals 220 as represented by the other arrows associated with transmitted signal 220b).

First transmitted signal 220a travels through ocean 240 and arrives at first refraction/reflection point 222a. First reflected signal 224a, generated when a portion of the first transmitted signal 220a is reflected by the ocean floor 242, travels upward and back to receivers 140. As those of skill in the art can appreciate, whenever a signal—optical or acoustical—travels through a first medium with a first index of refraction n1 and then into a second, different medium, with a second index of refraction n2, a portion of the transmitted signal is reflected at an angle equal to the incident angle (according to the well-known Snell's law), and another portion of the transmitted signal can be refracted at a different angle (again according to Snell's law) and continues to travel through the second medium.

Thus, as shown in FIG. 2, first transmitted signal 220a generates first reflected signal 224a, and first refracted signal 226a. First refracted signal 226a travels through sediment layer 216 beneath ocean floor 242, and can now be considered to be a “new” transmitted signal, such that when it encounters a second medium at second refraction/reflection point 228, a second reflected signal 230a and refracted signal 232a, are subsequently generated. Further, as shown in FIG. 2, there happens to be a significant hydrocarbon deposit 244 within a third medium, or solid earth/rock layer 218. Consequently, reflected signals 236a and refracted signals 238a are generated at the interface 234a with the hydrocarbon deposit 244, and it is at least one purpose of seismic acquisition system 100 to generate data that can be used to discover such hydrocarbon deposits 244, based upon the various reflected signals 224a, 230a and 236a received by receivers 140.

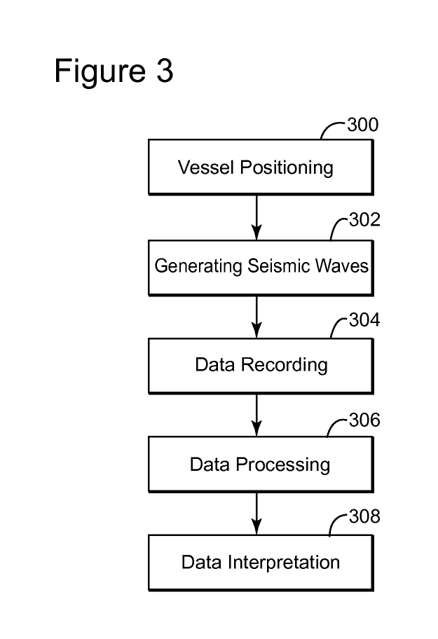

As generally discussed above, one purpose of seismic exploration is to render the most accurate graphical representation possible of specific portions of the Earth's subsurface geologic structure, e.g., using the data which is collected as described above with respect to FIGS. 1 and 2. The images produced allow exploration companies to accurately and cost-effectively evaluate a promising target (prospect) for its oil and gas yielding potential (i.e., hydrocarbon deposits 244). FIG. 3 illustrates a generalized method for seismic exploration which includes both the acquisition of the seismic data described above, and the subsequent processing of that seismic data to form such images. In FIG. 3, the overall process is broken down into five steps, although one could of course characterize seismic exploration in a number of different ways. Step 300 references the initial positioning of the survey vessel(s) in the GAI and preparation to begin traversing the GAI in a manner which is precise and repeatable. For each pass of the GAI, seismic waves are generated by the afore-described sources (step 302), and data recording is performed on the reflected waves by the receivers (step 304). In step 306, processing of the raw, recorded seismic data occurs. Data processing generally involves numerous processes intended to, for example, remove noise and unwanted reflections from the recorded data and involves a significant amount of computer processing resources, including the storage of vast amounts of data, and multiple processors or computers running in parallel. Such data processing can be performed on board the survey vessel(s), back at a data processing center, or some combination thereof. Finally, in step 308, data interpretation occurs and the results can be displayed or generated as printed images, sometimes in two-dimensional form, more often now in three dimensional form. Four dimensional data presentations (i.e., a sequence of 3D plots or graphs over time) are also possible outputs, when needed to track the effects of, for example, extraction of hydrocarbons from a previously surveyed deposit.

As mentioned earlier, the towed arrays including the birds and streamers may be submerged in the ocean waters for long periods of time and, accordingly, are susceptible to marine growth such as barnacles and marine algae. As such marine growth forms on the arrays and their components, this can increase drag on the arrays which in turn results in lower shooting speeds, increased fuel usage, increased wear to streamer head equipment due to increased tension and degradation of the received data due to the increase in noise, thus impacting a number of the steps associated with seismic exploration that were discussed above with respect to FIG. 3.

As mentioned in the Background, one solution is to clean the marine growth from the affected surfaces of the birds and/or streamers, e.g., by scraping off the marine growth. However since the streamers can be on the order of kilometers in length, this is a tedious and expensive undertaking and it would be better to retard or prevent their growth in the first instance. Recently, there have been introduced various coatings which may be capable of inhibiting marine growth by virtue of their capability to prevent water from contacting surfaces to which they are applied, i.e., so-called hydrophobic or superhydrophobic coatings.

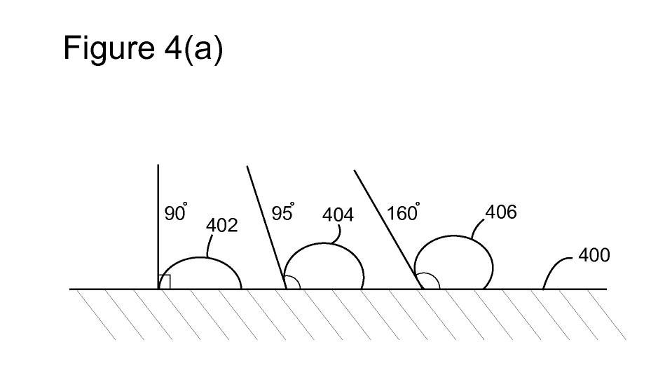

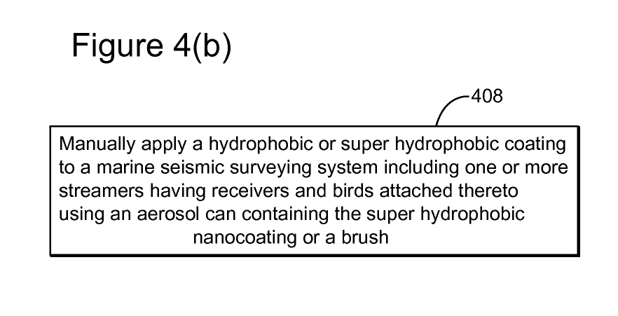

In defining hydrophobic or superhydrophobic coatings, consider that the contact angle of water disposed on a surface is the angle of the leading edge of a water droplet on that surface as measured from the center of the droplet. To visualize contact angles of water, consider that a surface having a contact angle of water of 180 degrees would mean that water droplets sit on that surface as a perfect sphere and have only a tangential point of contact with the surface, such that the angle formed between the surface and the gas/water interface is about 180 degrees. By way of contrast, on a surface with a contact angle of water that is less than 180 degrees, the droplet would not be perfectly spherical because it would have an area of contact with the surface that increases in size as the contact angle decreases, forming a smaller contact angle between the surface and the gas/water interface. Such surfaces with smaller contact angles of water enable water to adhere to those surfaces more readily. Various contact angles are illustrated in FIG. 4(a) which shows three water droplets on a surface 400, and where it can be seen (from left to right) that as the contact angles of water droplets 402, 404 and 406 increase relative to surface 400, the water droplet becomes more spherical. Although not shown in FIG. 4(a) it will be appreciated that if the water droplet was a perfect sphere, having a single point of contact with the surface 400, then the contact angle would be the 180 degrees, i.e., the tangent of the surface itself contacting a single point on the droplet's sphere.

Thus, “hydrophobic coatings”, as that phrase is used herein, are those coatings having contact angles with water that are between 90 degrees and 180 degrees, with “superhydrophobic coatings” providing a contact angle with water of between 150-180 degrees. Recently such coatings have been developed that are quite thin, i.e., so-called nanocoatings which have a thickness of at least one layer on the scale of nanometers. Some of the embodiments described herein refer to hydrophobic or superhydrophobic nanocoatings, whereas others refer simply to coatings.

However the application of hydrophobic or superhydrophobic nanocoatings to marine seismic surveying equipment is not straight forward, as some such nanocoatings require vacuum chambers or thermal deposition chambers in which it would be difficult or impossible to position large or lengthy seismic streamers and/or birds. Moreover, applying such coatings to marine seismic survey equipment which is already on board a towing vessel using such equipment would be even more problematic.

Recently, however, there have been announced newer superhydrophobic nanocoatings which can be applied manually, e.g., via an aerosol can or a brush. For example, Ross Nanotechnology of Lancaster, Pa. has announced a new superhydrophobic nanocoating marketed under the tradename of NeverWet™ which can be applied manually via an aerosol can. Accordingly, this product, or the like, can be used according to these embodiments to apply a hydrophobic or superhydrophobic coating to marine seismic surveying equipment, including sources, streamers, streamer sections, birds and elements thereof which have significant exposure to ocean waters and are susceptible to marine growth. Thus some embodiments described herein contemplate a marine seismic surveying system including one or more streamers having receivers attached thereto, as well as a plurality of birds attached to the streamers for positioning the streamers, wherein at least a surface of the birds and/or the streamers are coated with a hydrophobic or superhydrophobic coating. In terms of a process, as shown in FIG. 4(b), embodiments contemplate the manual application of a hydrophobic or superhydrophobic coating to a surface of a marine seismic surveying system including one or more streamers having receivers and birds attached thereto, e.g., using an aerosol can containing the hydrophobic or superhydrophobic coating, as depicted in step 408.

As another illustrative example of suitable superhydrophobic coatings which can be used in these embodiments, the interested reader is directed to U.S. Published Patent Application 20120045954 entitled “HIGHLY DURABLE SUPERHYDROPHOBIC. OLEOPHOBIC AND ANTI-ICING COATINGS AND METHODS AND COMPOSITIONS FOR THEIR PREPARATION” to Douglas Bleecher et al., the disclosure of which is incorporated here by reference, although the embodiments disclosed herein are not limited thereto. For example, as stated in that document, a coating to a substrate may apply a coating composition to a substrate where the components include: i) a binder; ii) first particles having a size of about 30 microns to about 225 microns; and iii) second particles having a size of about 1 nanometer to 25 microns. Optionally, one or more independently selected alkyl, haloalkyl, or perfluoroalkyl groups may be covalently bound, either directly or indirectly, to the second particles. The composition optionally may contain 5% to 10% of a block copolymer on a weight basis. The composition may also contain any necessary solvents/liquids to assist in the application process. More details regarding suitable particles, etc., can be found in the above-incorporated by reference, published patent application.

While manual application of such a coating will provide significant flexibility toward the process of coating lengthy seismic arrays, it may also be difficult to manually coat entire streamer runs (extending potentially several kilometers) in this way. Thus, according to other embodiments it may be desirable to strategically select those surfaces on the streamers and/or birds which are particularly susceptible to marine growth and to only coat those surface(s) with the hydrophobic or superhydrophobic coating. Some possible strategic selections include, for example, only surfaces of the streamers, only surfaces of the bodies of the birds, and/or only one or more components associated with the birds, e.g., a bird depth indictor which is particularly susceptible to giving false readings due to barnacle growth. Other selections of surfaces of the marine seismic surveying equipment to coat with the hydrophobic or superhydrophobic coating are also possible.

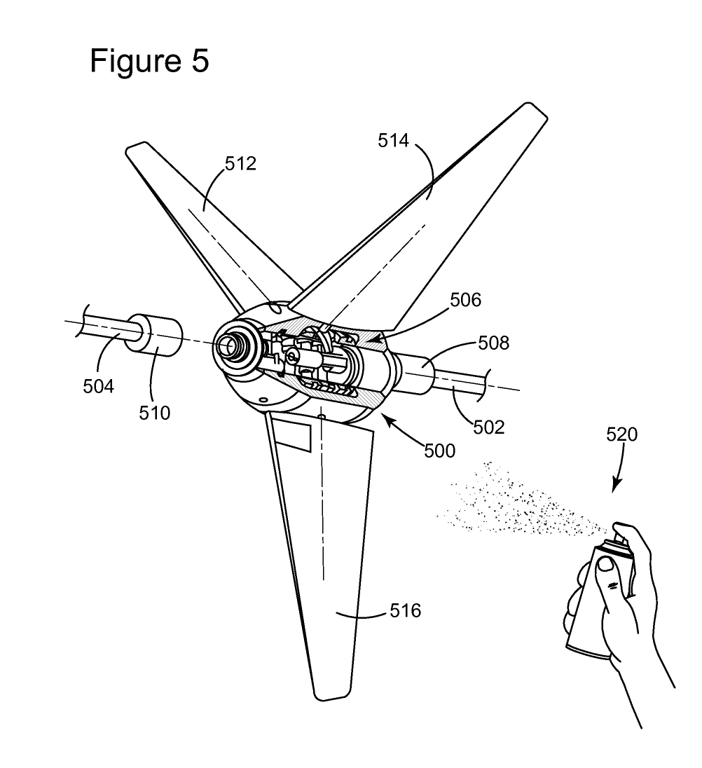

To better illustrate some of the surfaces of interest on which to inhibit the marine growth using, e.g., superhydrophobic coatings according to embodiments, consider the example of a bird 500 connected to streamer sections 502 and 504 as shown in FIG. 5. Various surfaces of the bird 500 and/or streamer 502, 504 can be selectively coated with the superhydrophobic coating, e.g., by spraying the coating onto the selected surface with an aerosol can either on board the towing vessel or, even when raised from the ocean using a motorized dilfloat for, e.g., other maintenance purposes. These selected surfaces could also include (or only be), one or more of: the body of the bird 506, the streamer connectors 508, 510, or the bird's wings (fins) 512, 514, 516. The manual application of the coating to one or more of these surfaces is generally illustrated by aerosol delivery device 520.

In addition to applying such coatings manually using an aerosol delivery device 520, other embodiments contemplate manual application by way of, e.g., a brush. For example, Takeda Printing Co., Ltd. offers a hydrophobic nanocoating having a contact angle with water of 110-115 degrees which is applicable via brush. Those skilled in the art will appreciate that there may be other ways to apply such coatings in addition to aerosol cans and brushes. In addition to exterior surfaces of birds and/or streamers, it may also be desirable to apply such coatings to interior surfaces or specific components which are exposed to sea water. For example, a bird's depth indicator may, for example, be implemented as a pressure sensor disposed in a cavity in the bird's housing. Such interior surfaces may also benefit from the application of a hydrophobic or superhydrophobic nanocoating as discussed above.

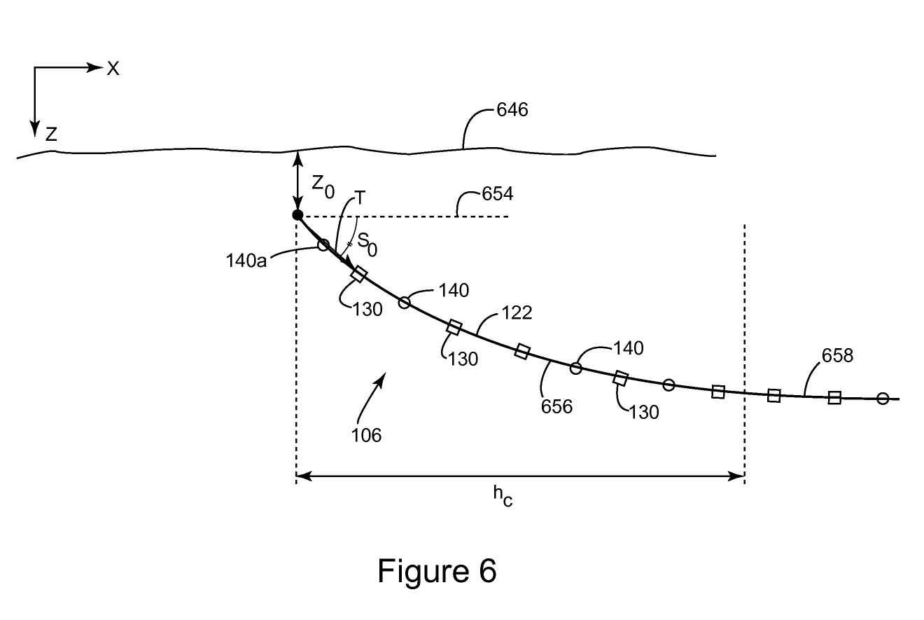

As described above, streamers 106 are towed by one or more vessels/ships 102 and the streamers 106 include seismic receivers/detectors 140. The streamers 106 can be controlled to have a horizontal, slanted or curved profile in the water, the latter of which is illustrated in FIG. 6. The curved streamer 106 of FIG. 6 includes a body or cable 212 having a predetermined length; plural detectors 140 provided along the body 212; and plural birds 130 provided along cable 212 for maintaining the selected curved profile. Curved streamer 106 is configured to travel underwater when towed such that the plurality of detectors 140 is distributed along the curved profile. The curved profile can also be described by as parameterized curve, e.g., a curve described by (i) a depth z₀ of a first detector 140a (measured from the water surface 646), (ii) a slope s₀ of a first portion T of cable 212 with an axis 654 parallel with water surface 646, and (iii) a predetermined horizontal distance h_{c} between the first detector 140a and an end of the curved profile. It should be noted that the entire streamer 106 does not have to have a curved profile. For example, the curved profile may be applied only to a first portion 656 of streamer 106. In other words, streamer 106 can have (i) only a first portion 656 having the curved profile or (ii) a first portion 656 having the curved profile and a second portion 658 having a flat profile, the two portions being attached to each other. One or more of the surfaces of the marine seismic equipment illustrated in FIG. 6 may be coated with a hydrophobic or superhydrophobic coating as described above.

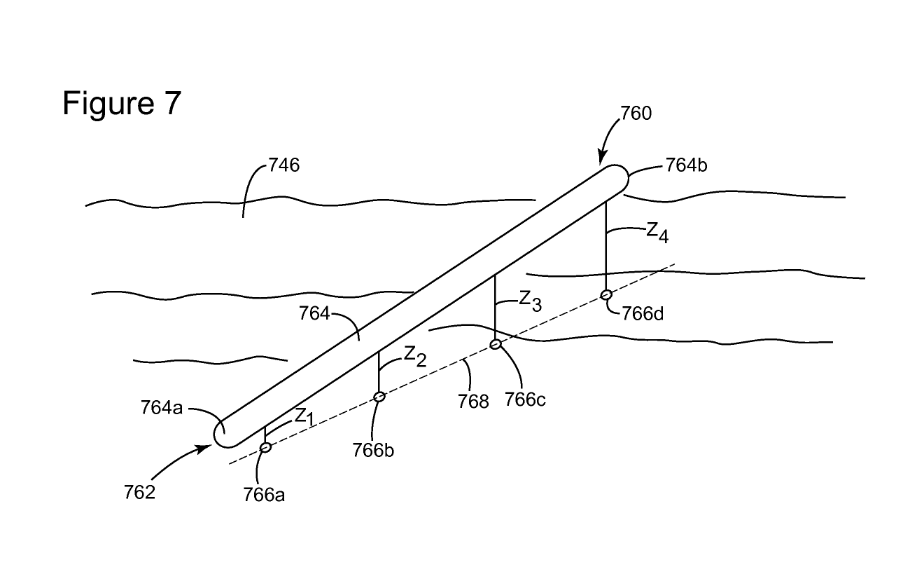

Further, the above embodiments may be used with multi-level source 760. FIG. 7 illustrates multi-level source 760 for use with marine seismic exploration system 100 shown in FIG. 1 according to an embodiment, e.g., as source 104a and/or 104b. Multi-level source 760 has one or more sub-arrays 762. The first sub-array 762 has a float 764 that is configured to float at the water surface 746 or underwater at a predetermined depth. Plural source points 766a-d are suspended from the float 764 in a known manner. A first source point 766a may be suspended closest to the head 764a of the float 764, at a first depth z1. A second source point 766b may be suspended next, at a second depth z2, different from z1. A third source point 766c may be suspended next, at a third depth z3, different from z1 and z2, and so on. FIG. 7 shows, for simplicity, only four source points 766a-d, but an actual implementation may have any desired number of source points 766. In one application, because source points 766 can be distributed at different depths, the source points 766 at the different depths are not simultaneously activated. In other words, the source array is synchronized, i.e., a deeper source point 766 is activated later in time (e.g., 2 ms for 3 m depth difference when the speed of sound in water is 1500 m/s) such that corresponding sound signals produced by the plural source points 766 coalesce, and thus, the overall sound signal produced by the source array appears as being a single sound signal.

The depths z1 to z4 of the source points of the first sub-array 762 can obey various relationships. In one application, the depths of source points 766 increase from head 764a toward the tail 764b of float 764, i.e., z1<z2<z3<z4. In another application, the depths of source points 766 decrease from head 764a to tail 764b of float 766. In another application, source points 766 are slanted, i.e., provided on an imaginary line 768. In still another application, line 768 is a straight line. In yet another application, line 768 is a curved line, e.g., part of a parabola, circle, hyperbola, etc. In one application, the depth of the first source point 766a for the sub-array 762 is about 5 m and the largest depth of the last source point 766d is about 8 m. In a variation of this embodiment, the depth range is between about 8.5 and about 10.5 m or between about 11 and about 14 m. In another variation of this embodiment, when line 768 is straight, the depths of the source points 766 increase by 0.5 m from a first source point to an adjacent source point. Those skilled in the art would recognize that these ranges are exemplary and these numbers may vary from survey to survey. A common feature of all these embodiments is that source points 766 have variable depths so that a single sub-array 762 exhibits multiple-level source points 766. According to embodiments, one or more surfaces associated with the source elements described above with respect to FIG. 7 can be coated with a hydrophobic or superhydrophobic coating.

Although the features and elements of the embodiments are described in the embodiments in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

1. A marine seismic acquisition system adapted to retard marine growth, the system comprising:
at least one towing vessel;
at least one source disposed on, or connected to, the at least one towing vessel and configured to generate acoustic waves;
at least one streamer connected to the at least one towing vessel and having a plurality of receivers associated therewith, the plurality of receivers configured to receive reflections of said acoustic waves; and
a plurality of birds attached to the at least one streamer and configured to assist in positioning the at least one streamer,
wherein at least one surface of either the at least one streamer, the at least one source and the plurality of birds is coated with a superhydrophobic nanocoating which has a contact angle with water of at least 150 degrees.

2. The marine seismic acquisition system of claim 1, wherein the superhydrophobic nanocoating is applied manually to the at least one surface.

3. The marine seismic acquisition system of claim 2, wherein coating of the superhydrophobic nanocoating on the at least one surface is performed onboard the at least one towing vessel.

4. The marine seismic acquisition system of claim 1, wherein the superhydrophobic nanocoating is only coated on a surface of the at least one streamer.

5. The marine seismic acquisition system of claim 1, wherein the superhydrophobic nanocoating is only coated on a surface of at least one of the plurality of birds attached to the at least one streamer.

6. The marine seismic acquisition system of claim 1, wherein the superhydrophobic nanocoating is only coated on at least one component of the plurality of birds.

7. The marine seismic acquisition system of claim 6, wherein the at least one component is a depth indicator disposed in an opening of a bird's housing and which indicates a depth of an associated bird.

8. The marine seismic acquisition system of claim 1, wherein the superhydrophobic nanocoating further comprises:
i) a binder; ii) first particles having a size of about 30 microns to about 225 microns; and iii) second particles having a size of about 1 nanometer to 25 microns.

9. A marine seismic acquisition system adapted to retard marine growth comprising:
at least one streamer having a plurality of receivers associated therewith, the plurality of receivers configured to receive reflections of said acoustic waves; and
a plurality of birds attached to the at least one streamer and configured to assist in positioning the at least one streamer,
wherein at least one surface of either the at least one streamer and the plurality of birds is coated with a hydrophobic coating which has a contact angle with water of at least 90 degrees.

10. The marine seismic acquisition system of claim 9, wherein the hydrophobic coating is applied manually.

11. The marine seismic acquisition system of claim 10, wherein application of the hydrophobic coating is performed onboard a vessel carrying the at least one streamer and plurality of birds.

12. The marine seismic acquisition system of claim 9, wherein the hydrophobic coating is a superhydrophobic coating which has a contact angle with water of at least 150 degrees.

13. The marine seismic acquisition system of claim 9, wherein the hydrophobic coating is only disposed the at least one streamer.

14. The marine seismic acquisition system of claim 9, wherein the hydrophobic coating is only disposed on the plurality of birds.

15. The marine seismic acquisition system of claim 9, wherein the hydrophobic coating is only disposed on at least one component of the plurality of birds.

16. The marine seismic acquisition system of claim 15, wherein the at least one component is a depth indicator which indicates a depth of an associated one of the plurality of birds.

17. The marine seismic acquisition system of claim 9, wherein the hydrophobic coating further comprises:
i) a binder; ii) first particles having a size of about 30 microns to about 225 microns; and iii) second particles having a size of about 1 nanometer to 25 microns.

18. A marine seismic acquisition system adapted to retard marine growth comprising:
at least one piece of seismic surveying equipment which has a hydrophobic coating on a surface thereof.

19. The marine seismic acquisition system of claim 18, wherein the at least one piece of seismic surveying equipment is one of: a streamer, a receiver disposed on the streamer, a source, a bird and a depth indicator disposed inside of the bird.

20. The marine seismic acquisition system of claim 19, wherein the hydrophobic coating is a superhydrophobic nanocoating having a contact angle with water of at least 150 degrees.

21. A method for processing seismic data with reduced noise, the method comprising:
acquiring seismic data using seismic equipment including at least one streamer having at least one bird attached thereto which are substantially unfouled with marine life;
wherein the seismic equipment is substantially unfouled with marine life due to at least one surface of either the at least one streamer and the at least one bird being coated with a hydrophobic coating which has a contact angle with water of at least 90 degrees.
wherein the acquired seismic data has reduced noise relative to seismic data which would be acquired using seismic equipment which is fouled with marine life; and
processing the acquired seismic data to produce an image of a geographical area of interest.
